(19) United States
(12) Patent Application Publication
(10) Pub. No.: US 2013/0033409 A1
(43) Pub. Date: Feb. 7, 2013

(54) Radiation Antenna for Wireless Communication

(71) Applicant: Dedimuni Rusiru Vinodaka Leelaratne, Broadoak Road Sittingbourne Kent (GB)

(72) Inventor: Dedimuni Rusiru Vinodaka Leelaratne, Broadoak Road Sittingbourne Kent (GB)

(73) Assignee: HARADA INDUSTRY CO., LTD., Tokyo (JP)

(21) Appl. No.: 13/565,132

(22) Filed: Aug. 2, 2012

(30) Foreign Application Priority Data
Aug. 3, 2011 (GB) GB1113374.1

(51) Int. Cl. H01Q 1/36; H01Q 1/50; H01Q 9/16

(52) U.S. Cl. 343/793; 343/895; 343/700 R; 343/860

(57) ABSTRACT

A radiation antenna for wireless communication provides an advantage of being able to enhance gain and control directionality, while suppressing the height. The radiation antenna for wireless communication includes a line antenna element 10 and arm elements 20. The line antenna element 10 extends from a power feed section 15. The arm elements 20 are connected to a tip portion of the far side from the power feed section 15 to enhance the gain of the line antenna element 10 and control the directionality thereof. The electrical length from the power feed section 15 to the open end of the arm elements 20 by way of the line antenna element 10 is designed to resonate at a higher order mode of a target frequency.

### BACKGROUND OF THE INVENTION

1. Technical Field

The present invention relates to a radiation antenna for wireless communication, and more particularly to a radiation antenna for wireless communication with an enhanced gain and controllable directionality.

2. Background Art

A radiation antenna for wireless communication using a line antenna element such as a monopole antenna or a dipole antenna generally has an electrical length equal to ¼ wavelength or ½ wavelength of a target frequency. The gain of such an antenna is generally about 2 dBi and a gain improvement is desired for such an antenna.

A collinear array antenna is known as a high gain antenna. The collinear array antenna is typically formed by stacking a plurality of vertically arranged dipole antennas to produce an array as disclosed in Patent Document 1.

An antenna that resonates at a higher order mode is also known. For example, an antenna disclosed in Patent Document 2 is designed to adapt itself to two frequency bands. More specifically, it is designed so as to be able to transmit and receive a signal of a first frequency band that is ¼ wavelength and a signal of a second frequency band that is twice as high as the first frequency and equal to ¾ wavelength. The antenna element having a total length equal to ¾ wavelength of the antenna is folded once to have a substantially parallel part in such a way that the parallel part and the ¼ wavelength part at the open end side may not be substantially in parallel with each other.

Another exemplary antenna element of ¾ wavelength is disclosed in Patent Document 3. In this example, meander antenna elements are added to both sides of the top of a T-shaped antenna element and the electrical length from a power feed point to the open end of each of the meander antenna elements is equal to ¾ wavelength of an FM radio broadcast signal. The antenna is designed to adapt itself to two frequency bands including the frequency band for an FM radio broadcast signal and that for an AM radio broadcast signal. The T-shaped antenna element part is for the FM radio broadcast signal and the part where the meander antenna elements are added to the T-shaped antenna element is for the AM radio broadcast signal.

### PRIOR ART DOCUMENTS

### Patent Documents

[Patent Document 1] Japanese Patent Application Kokai Publication No. Hei 09-232851
[Patent Document 2] Japanese Patent Application Kokai Publication No. Hei 10-56315
[Patent Document 3] Japanese Patent Application Kokai Publication No. 2011-35519)

### SUMMARY OF THE INVENTION

### Problems to be Solved by the Invention

However, in case of the collinear array antenna as disclosed in Patent Document 1, a plurality of dipole antennas need to be stacked to produce an array. Thus, such a collinear array antenna has a significant height and therefore a collinear array antenna is hardly used as a roof-mount antenna for automotive vehicles because of height limitations.

An antenna disclosed in Patent Document 2 has sections that run in parallel with each other and the ¼ wavelength part of the antenna element of ¾ wavelength needs to be folded so as not to be in parallel with those sections. Thus, such an antenna has to be subject to shape limitations. Also, the directionality cannot be controlled for directionality because of a large side lobe.

Finally, in the antenna disclosed in Patent Document 3, the electrical length is set to ¾ wavelength of an FM radio broadcast signal. However, this electrical length cannot accommodate ¾ wavelength of an AM radio broadcast signal and hence the antenna operates not as a radiation antenna but as a so-called capacity antenna for this part. Thus, the gain is small and directionality cannot be controlled in any desired direction.

In view of the above circumstances, an object of the present invention, therefore, is to provide a radiation antenna for wireless communication that can enhance gain and control directionality, while suppressing the height.

### Means for Solving the Problems

To achieve the above object of the present invention, according to one aspect of the present invention, there is provided a radiation antenna for wireless communication including: a line antenna element extending from a power feed section; and at least an arm element connected to a tip portion of a far side of the power feed section of the line antenna element for enhancing gain and controlling directionality of the line antenna element. The electrical length from the power feed section to an open end of the arm element through the line antenna element may be designed to resonate at a higher order mode of a target frequency.

The electrical length from the power feed section to the open end of the arm element through the line antenna element may be designed to resonate at an odd mode of equal to or more than 3rd order mode of a target frequency.

The electrical length from the power feed section to the open end of the arm element through the line antenna element may be designed to resonate at an even mode of equal to or more than 2nd order mode of a target frequency and the radiation antenna may further include an impedance transformer provided to the power feed section of the line antenna element.

The arm element may be provided to tilt with respect to a longitudinal direction of the line antenna element.

The arm element may be made by four arm elements.

The four arm elements may be arranged every 90 degrees on a center of the tip portion of the line antenna element as viewed in a longitudinal direction of the line antenna element.

The shape of the arm element may be any one of straight, helical and meandrous.

The line antenna element may include a dipole antenna element, and the arm element may be connected to each of tip portions of both far sides of the power feed section of the dipole antenna element.

### Advantages of the Invention

Thus, a radiation antenna for wireless communication according to the present invention provides an advantage of being able to enhance gain and control directionality, while suppressing the height of the antenna.

### BRIEF DESCRIPTION OF THE DRAWINGS

FIG. 1 is a schematic view of a radiation antenna for wireless communication according to the first embodiment of the present invention.

FIG. 2 is a view illustrating the results of a simulation of the directionality of the radiation antenna for wireless communication according to the first embodiment of the present invention.

FIG. 3 is a view illustrating the results of a simulation of the directionality of the radiation antenna for wireless communication according to the first embodiment of the present invention illustrated in FIG. 1.

FIG. 4 is a view illustrating the results of a simulation of the directionality of the radiation antenna for wireless communication according to the first embodiment of the present invention obtained when each of the arm elements thereof is tilted by 30 degrees from a horizontal plane.

FIG. 5 is a view illustrating the results of a simulation of the directionality of the radiation antenna for wireless communication according to the first embodiment of the present invention obtained when each of the arm elements thereof is tilted by 15 degrees from a horizontal plane.

FIG. 6 is a view illustrating the results of a simulation of the directionality of the radiation antenna for wireless communication according to the first embodiment of the present invention obtained when each of the arm elements thereof is held on a horizontal plane.

FIG. 7 is a schematic perspective view of the radiation antenna for wireless communication according to the first embodiment of the present invention when it is made to include two arm elements.

FIG. 8 is a view illustrating the results of a simulation of the directionality of the radiation antenna for wireless communication according to the first embodiment of the present invention when it is made to include two arm elements as shown in FIG. 7.

FIG. 9 is a schematic perspective view of the radiation antenna for wireless communication according to the first embodiment of the present invention when it is made to include only a single arm element.

FIG. 10 is a view illustrating the results of a simulation of the directionality of the radiation antenna for wireless communication according to the first embodiment of the present invention when it is made to include only a single arm element as shown in FIG. 9.

FIG. 11 is a schematic perspective view of the radiation antenna for wireless communication according to the first embodiment of the present invention when it is made to include eight arm elements.

FIG. 12 is a view illustrating the results of a simulation of the directionality of the radiation antenna for wireless communication according to the first embodiment of the present invention when it is made to include eight arm elements as shown in FIG. 11.

FIG. 13 is a schematic perspective view of a radiation antenna for wireless communication according to the second embodiment of the present invention.

FIG. 14 is a view illustrating the results of a simulation of the directionality of the radiation antenna for wireless communication according to the second embodiment of the present invention as shown in FIG. 13.

FIG. 15 is a schematic perspective view of a radiation antenna for wireless communication according to the third embodiment of the present invention.

### PREFERRED EMBODIMENTS OF THE INVENTION

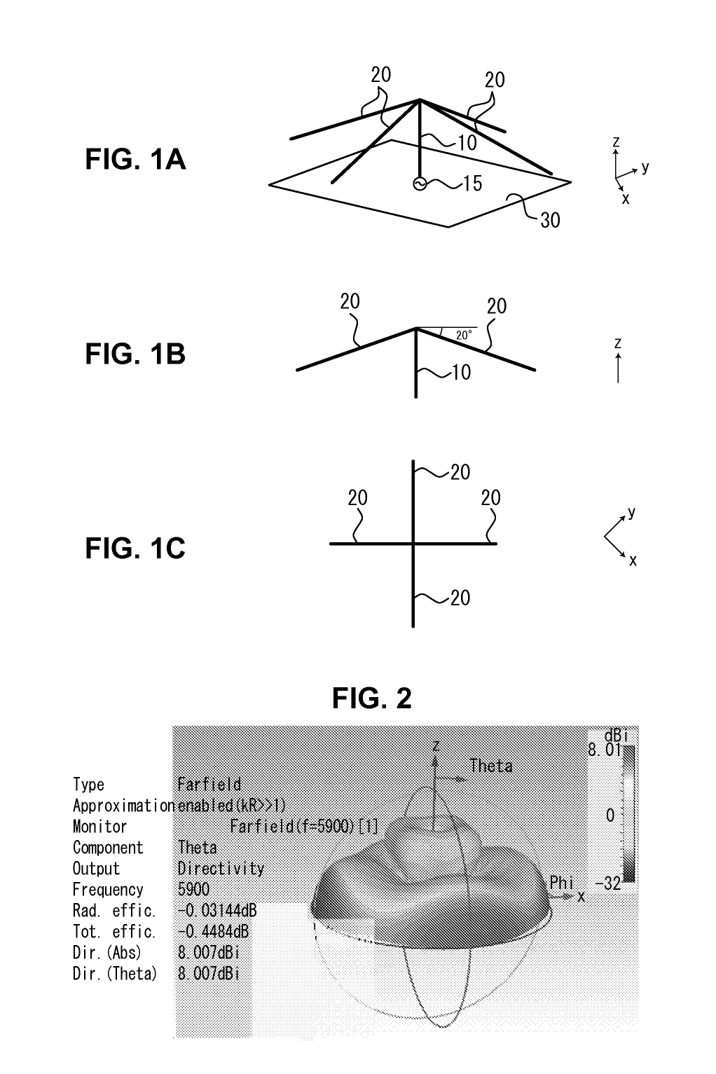

Now, preferred embodiments of the present invention will be described below by referring to the accompanying drawings. FIG. 1 is a schematic view of a radiation antenna for wireless communication according to the first embodiment of the present invention. FIG. 1A is a perspective view, FIG. 1B is a front view and FIG. 1C is a top view of the embodiment. As shown, the radiation antenna for wireless communication according to the first embodiment of the present invention includes as major components thereof a line antenna element 10 and an arm element 20. As shown in FIG. 1A, the line antenna element 10 and the arm element 20 are arranged on a ground plane 30.

The line antenna element 10 extends from a power feed section 15. The power feed section 15 is designed to feed power to the antenna element by way of a hole normally formed at a predetermined position of the ground plane 30. More specifically, the line antenna element 10 shows a cylindrical or prismatic shape, for example, or a circular or polygonal cross section taken in a direction perpendicular to the longitudinal direction, and is made of a conductive material. In the illustrated example, the line antenna element 10 is a linear monopole antenna element.

The arm element 20 is connected to a tip portion of the far end of the line antenna element 10 as viewed from the power feed section 15. In the illustrated example, four arm elements 20 are connected to the tip portion of the line antenna element 10. The arm element 20 is or the arm elements 20 are provided to enhance gain and control directionality of the line antenna element 10. The arm element 20 or each of the arm elements 20 shows a cylindrical or prismatic shape, for example, or a circular or polygonal cross section taken in a direction perpendicular to the longitudinal direction and is made of a conductive material. In the illustrated example, the arm elements 20 are so arranged as to be tilted relative to the longitudinal direction of the line antenna element 10. More specifically, as shown in FIG. 1B, the arm elements 20 are arranged to show an angle of 160 degrees relative to the line antenna element 10 (and 20 degrees from a horizontal plane). As shown in FIG. 1C, the arm elements 20 are arranged at every 90 degrees at the center of the tip portion of the line antenna element 10 as viewed in a longitudinal direction of the line antenna element 10 and turned around the z-axis by 45 degrees from the x- and y-axes. Directionality control by the arm elements 20 will be described in detail hereinafter.

Now, the electrical length of the line antenna element 10 and that of the arm elements 20 will be described below. The electrical length from the power feed section 15 to the open end of the arm element 20 by way of the line antenna element 10 is designed so as to resonate at a higher order mode of a target frequency. When a plurality of arm elements 20 are provided, the electrical length refers to the length from the power feed section 15 to the open end of each of the arm elements 20. A target frequency refers to the 5.8 GHz band in the case of Intelligent Transport Systems (ITS) and 2.4 GHz band in the case of Bluetooth (registered trademark), although the present invention is also applicable to any of other various frequency bands such as the frequency band of Wi-Fi (registered trademark) and the frequency band of WiMAX (registered trademark). Note that a radiation antenna for wireless communication according to the present invention is not limited to these frequency bands and applicable to any other frequency band.

A higher order mode refers to a second or higher order mode and hence an electrical length not equal to ¼ wavelength but to n/4 (n=2, 3, 4, . . . ) wavelength of a target frequency. The radiation antenna for wireless communication can enhance gain when the electrical length is designed to resonate at a second or higher order mode. With regard to the electrical length, it may not necessarily be designed physically exactly as n/4 wavelength and may be reduced according to the velocity factor.

When the electrical length from the power feed section 15 to the open end of the arm element 20 by way of the line antenna element 10 is designed so as to resonate at an odd mode of a third or higher order mode, for example, the electrical length will be equal to ¾ wavelength of a target frequency. When the electrical length is designed to be equal to ¾ wavelength, the line antenna element 10 may be equal to ¼ wavelength and the arm element 20 may be equal to ½ wavelength. More specifically, if the target frequency is the 5.8 GHz band of Intelligent Transport Systems, the line antenna element may be designed to be equal to 12.5 mm and the arm element may be designed to be equal to 25 mm to make the total length equal to 37.5 mm. When the electrical length is designed to be equal to 5/4 wavelength, the line antenna element 10 may be designed to be equal to ¼ wavelength and the arm element 20 may be designed to be equal to the wavelength. So long as the total length is designed to resonate at an odd mode of a third or a higher order mode, the ratio of the length of the line antenna element 10 to that of the arm element 20 may not necessarily be limited to a specific value.

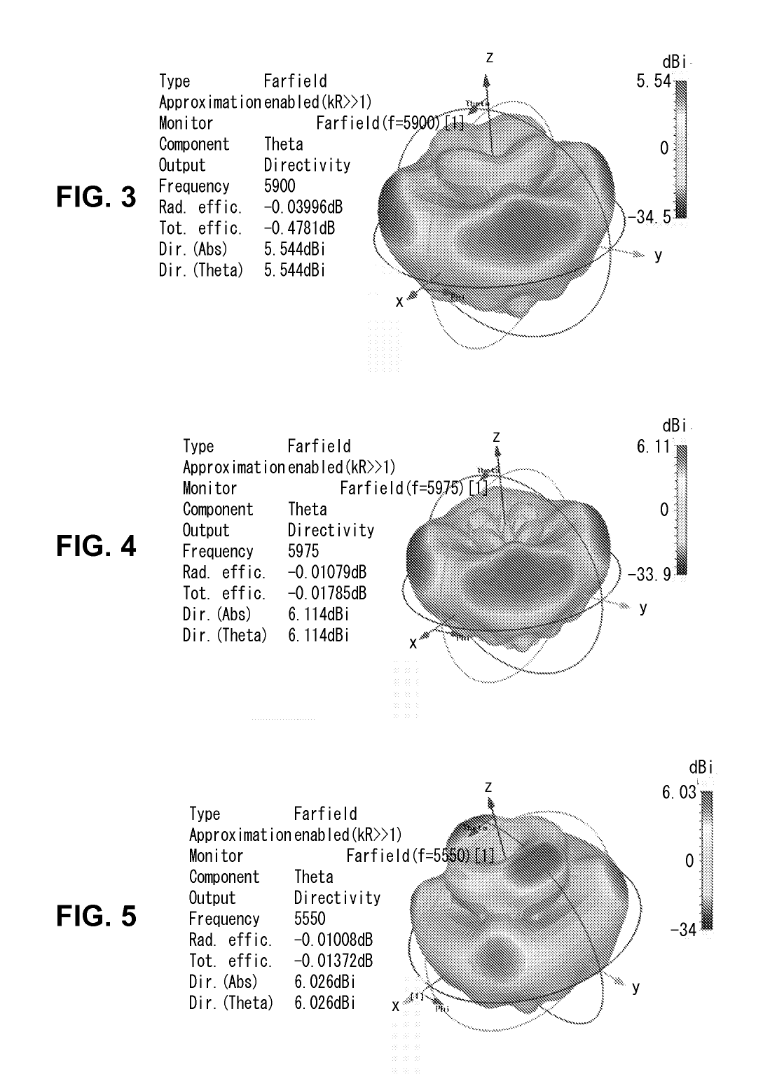

Now, the directionality of the radiation antenna for wireless communication according to the first embodiment of the present invention will be described below by referring to FIG. 2. FIG. 2 is a view illustrating the results of a simulation of the directionality of the radiation antenna for wireless communication according to the first embodiment of the present invention. Note that an infinite ground plane was used as ground plane in FIG. 2. FIG. 3 is a view illustrating the results of a simulation of the directionality of the radiation antenna for wireless communication according to the first embodiment of the present invention, where a finite ground plane was used as ground plane as illustrated in FIG. 1. Also note that the arm elements are aligned with the x- and y-axes as viewed in the longitudinal direction of the line antenna element only for the simulation of FIG. 2, whereas the arm elements are turned around the z-axis by 45 degrees from the x- and y-axes in all the other simulations. And note that an infinite ground plane was used as ground plane only for the simulation of FIG. 2, whereas a finite ground plane was used as ground plane for each of the other simulations unless noted otherwise.

It is known that the directions of radiation are tilted upwardly relative to the x-y plane with an angle of elevation for ordinary monopole antennas. On the other hand, it will be seen from FIG. 2 that the directions of radiation according to the present invention are horizontal. It will also be seen that regions of the highest gain are found in the directions where the arm element are provided, that is, in the directions of the open ends of the arm elements as viewed at the x-y plane. Additionally, the gain is improved in the regions of the highest gain to about 8.01 dBi where an infinite ground plane was used and to about 5.54 dBi where a finite ground plane was used. The radiation patterns show concentrated high gain regions in the four directions where arm elements are arranged. Thus, antennas showing directionality in a plurality of directions were realized. In the case of Intelligent Transport Systems, for example, antennas showing directionality in directions close to a horizontal plane are preferable for communications between automatic vehicles. Therefore, an antenna showing characteristics as illustrated in FIG. 3 can advantageously find applications in Intelligent Transport Systems.

FIG. 4 is a view illustrating the results of a simulation of the directionality of the radiation antenna for wireless communication obtained when each of the arm elements thereof is tilted by 30 degrees from a horizontal plane. When each of the arm elements is tilted by 30 degrees from a horizontal plane (or the x-y plane), the highest gain is 6.11 dBi. It will also be seen that the upwardly directed side lobe (in the z-direction) is reduced when compared with the results shown in FIG. 3. Additionally, it will be seen that the high gain region is directed toward the open ends of the arm elements and obliquely upward (with an angle of elevation) as viewed on the x-y plane. As for the angle of the obliquely upward direction of the highest gain region, it will be seen that the angle is tilted slightly horizontally because the tilt angle of the arm elements are reduced from 20 degrees of FIG. 3 to 30 degrees.

FIG. 5 is a view illustrating the results of a simulation of the directionality of the radiation antenna for wireless communication obtained when each of the arm elements thereof is tilted by 15 degrees from a horizontal plane. When each of the arm elements is tilted by 15 degrees from a horizontal plane, the highest gain is 6.03 dBi. The directionality is more remarkable not only in horizontal directions (along the x-y plane) but also in the upward direction (the z-direction). In other words, it is possible to realize an antenna showing directionality in greater number of directions. As for the angle of the obliquely upward direction of the highest gain region, it will be seen that the angle is slightly increased because the tilt angle of the arm elements are changed from 20 degrees of FIG. 3 to 15 degrees. Therefore, an antenna showing characteristics as illustrated in FIG. 5 can advantageously find applications in occasions where an automotive vehicle communicates with roadside infrastructure such as a communication facility because such an antenna has upward directionality to a certain extent.

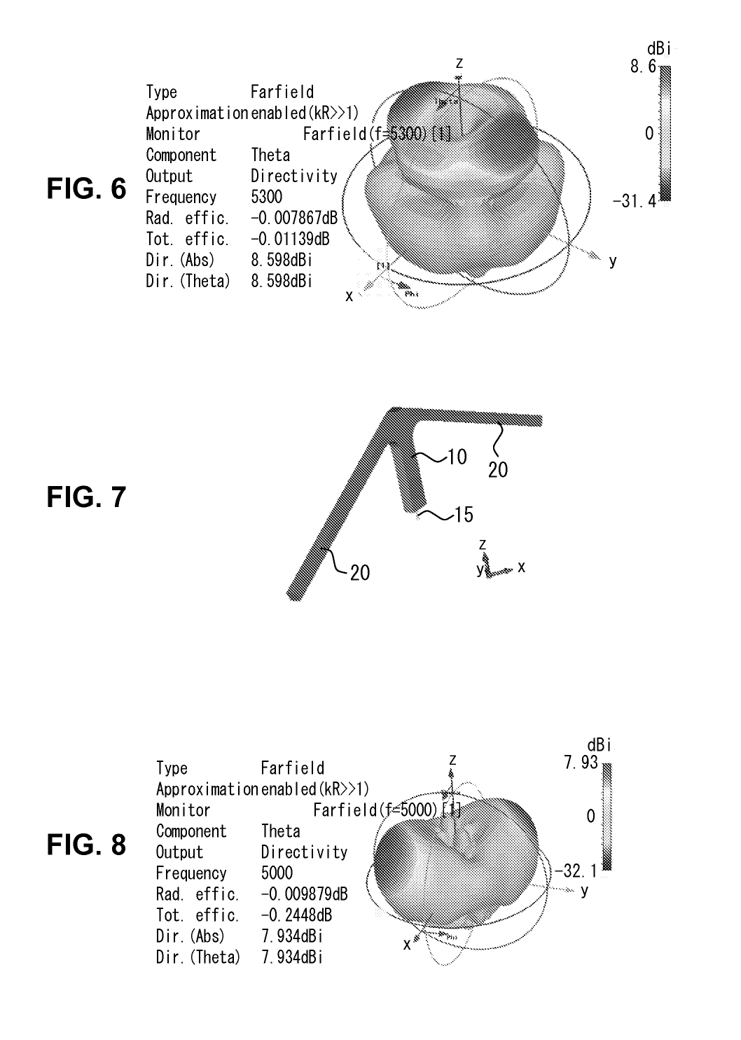

FIG. 6 is a view illustrating the results of a simulation of the directionality of the radiation antenna for wireless communication obtained when each of the arm elements thereof is held on a horizontal plane. When each of the arm elements is held on a horizontal plane, the highest gain is 8.6 dBi. The directionality is even more remarkable in the upward direction (the z-direction). Such an antenna can also advantageously find applications in occasions where an automotive vehicle communicates with roadside infrastructure such as a communication facility.

Thus, a radiation antenna for wireless communication according to the present invention can shift its directionality simply by changing the angle of the arm elements. Additionally, the gain of such an antenna can be improved to a large extent if compared with a simple monopole antenna. More specifically, when the arm elements are tilted from a horizontal plane by a large angle, the main radiation pattern (main lobe) having a high gain is directed toward directions that are close to a horizontal plane and the side lobe is reduced and directed upward. As the angle from a horizontal plane of the arm elements is reduced, the main lobe is reduced whereas the side lobe is increased. The main lobe is directed upward when the angle of elevation of the arm elements get to a certain value. The directions of radiation of the upwardly directed main lobe on the x-y plane do not agree with the angular positions of the arm elements as viewed in the longitudinal direction of the line antenna element. The gain of the main lobe increases as the angle of the arm element from a horizontal plane is reduced. In other words, the angles of radiation do not linearly change simply as a function of the angular positions of the arm elements but shows various directions of radiation and the gain of the main lobe gradually rises once the angle of elevation of the arm elements gets to a certain value.

Now, an example where the radiation antenna for wireless communication according to the first embodiment of the present invention is made to include two arm elements will be described below. FIG. 7 is a schematic perspective view of the radiation antenna for wireless communication according to the first embodiment of the present invention when it is made to include two arm elements. As shown, in this embodiment, a line antenna element 10 extends from a power feed section 15 and two arm elements 20 are connected to a tip portion of the far side of the line antenna element 10 as viewed from the power feed section 15. As shown in FIG. 7, the two arm elements 20 are arranged at the center of the tip portion of the line antenna element 10 and angularly separated from each other by 180 degrees as viewed in the longitudinal direction of the line antenna element 10.

Thus, the radiation antenna for wireless communication according to the first embodiment of the present invention may include two arm elements. The directionality of the radiation antenna can be controlled by means of the two arm elements. FIG. 8 is a view illustrating the results of a simulation of the directionality of the radiation antenna for wireless communication according to the first embodiment of the present invention when it is made to include two arm elements as shown in FIG. 7. As can be seen, the radiation pattern has regions showing the highest gain that are found in the directions of the open ends of the arm elements as viewed on the x-y plane under the influence of the arm elements. The highest gain of the high gain regions is improved up to 7.93 dBi. The improvement of the highest gain relative to the use of four arm elements is achieved because no radiation takes place in the directions where no arm elements are arranged and hence energy is intensified at the two directions of the arm elements. The directionality of the antenna can be controlled in a predetermined direction by adjusting the angle of the arm elements.

In the example illustrated in FIG. 7, the two arm elements 20 are arranged at the center of the tip portion of the line antenna element 10 and angularly separated from each other by 180 degrees as viewed in the longitudinal direction of the line antenna element 10. However, the present invention is not limited to such an arrangement. For example, two arm elements may alternatively be arranged at a side of the line antenna element in such a way that they form a V-shape as viewed in the longitudinal direction of the line antenna element. Then, the radiation pattern is made to have a region in the direction of the combined open ends of the arm elements that are arranged to form a V-shape where the gain is highest as viewed on the x-y plane. In this way, the directionality of the antenna can be controlled in an intended direction.

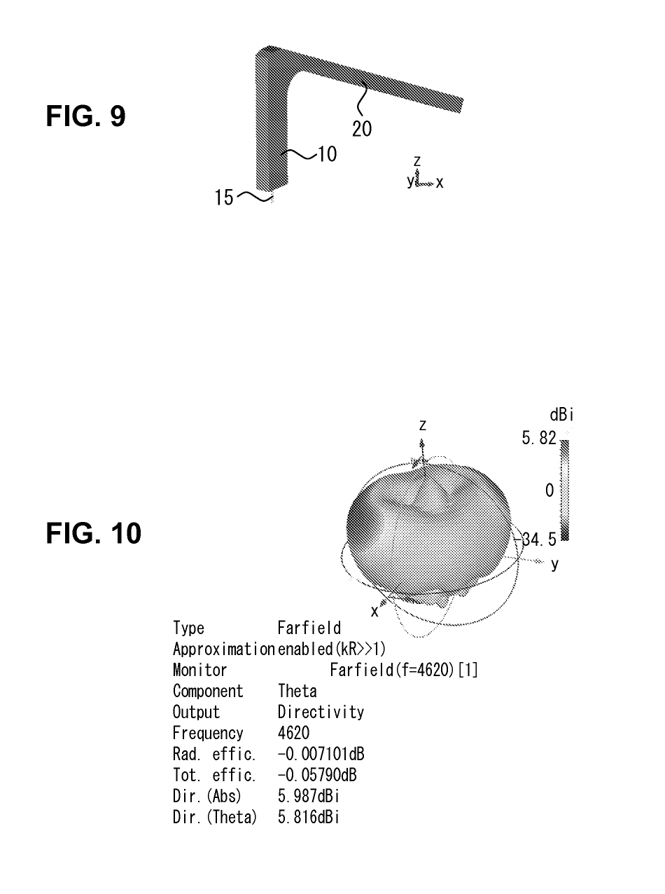

Now, an example where the radiation antenna for wireless communication according to the first embodiment of the present invention is made to include only a single arm element will be described below. FIG. 9 is a schematic perspective view of the radiation antenna for wireless communication according to the first embodiment of the present invention when it is made to include only a single arm element. As shown, in this embodiment, a line antenna element 10 extends from a power feed section 15 and a single arm element 20 is connected to a tip portion of the far side of the line antenna element 10 as viewed from the power feed section 15.

Thus, the radiation antenna for wireless communication according to the first embodiment of the present invention may include a single arm element. FIG. 10 is a view illustrating the results of a simulation of the directionality of the radiation antenna for wireless communication according to the first embodiment of the present invention when it is made to include only a single arm element as shown in FIG. 9. As can be seen, the radiation pattern has a region showing the highest gain that is found in a direction a little closer to the z-axis when compared with the radiation pattern of FIG. 8 obtained by using two arm elements under the influence of the arm element. The highest gain of the high gain region is improved up to about 5.82 dBi. A radiation antenna showing such radiation characteristics can also find applications. The directionality of the antenna can be controlled in a predetermined direction by adjusting the angle of the arm element.

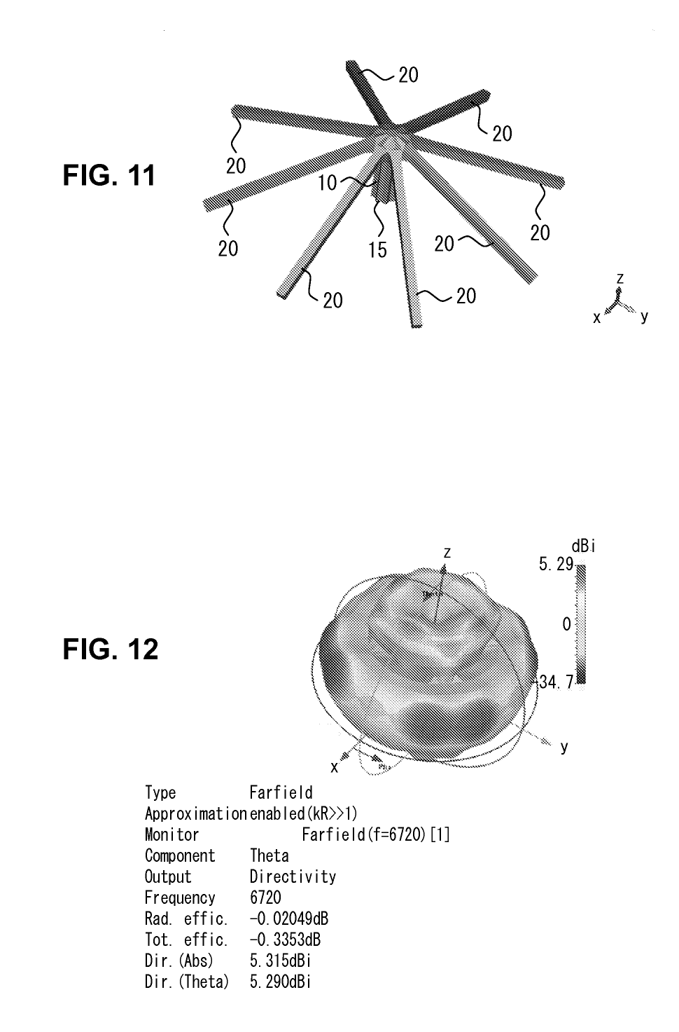

Now, an example where the radiation antenna for wireless communication according to the first embodiment of the present invention is made to include eight arm elements will be described below. FIG. 11 is a schematic perspective view of the radiation antenna for wireless communication according to the first embodiment of the present invention when it is made to include eight arm elements. As shown, in this embodiment, a line antenna element 10 extends from a power feed section 15 and eight arm elements 20 are connected to a tip portion of the far side of the line antenna element 10 as viewed from the power feed section 15. In the illustrated example, any two adjacently located ones of the eight arm elements 20 are angularly separated from each other by 45 degrees and radially extend from the tip portion of the line antenna element 10 as viewed in the longitudinal direction of the line antenna element 10.

Thus, the radiation antenna for wireless communication according to the first embodiment of the present invention may include eight arm elements. The directionality of the radiation antenna can be finely controlled by means of the eight arm elements. FIG. 12 is a view illustrating the results of a simulation of the directionality of the radiation antenna for wireless communication according to the first embodiment of the present invention when it is made to include eight arm elements as shown in FIG. 11. As can be seen, the radiation pattern has regions showing the highest gain that are found in the directions of the open ends of the arm elements as viewed on the x-y plane under the influence of the arm elements. Thus, it will be seen that this antenna shows directionality in a larger number of directions. The highest gain of the high gain regions is improved up to about 5.29 dBi.

As described above, a radiation antenna for wireless communication according to the present invention can be made to improve the gain of the line antenna element and the directionality thereof can be controlled by means of the arm element. Additionally, the number and the angle of arm elements can be selected appropriately and is not limited to the illustrated example s that are described above so that a radiation antenna according to the present invention can be adjusted in various ways to produce a desired radiation pattern. While the height of a radiation antenna for wireless communication according to the present invention depends on the length of the line antenna element thereof, the height can be suppressed unlike conventional collinear array antennas that are formed by stacking dipole antennas.

Furthermore, while the line antenna element and the arm element of a radiation antenna according to the present invention have a three-dimensional shape in the above description, the present invention is not limited thereto and the line antenna element and the arm element may be formed as so many thin film patterns on a substrate by means of a patterning method in a two-dimensional shape.

While the arm element of a radiation antenna according to the present invention has a linear shape in the above description, the present invention is not limited thereto and it may alternatively has a helical or meander shape. Then, the arm element extends longitudinally and is formed to show a helical or meander shape toward its open end.

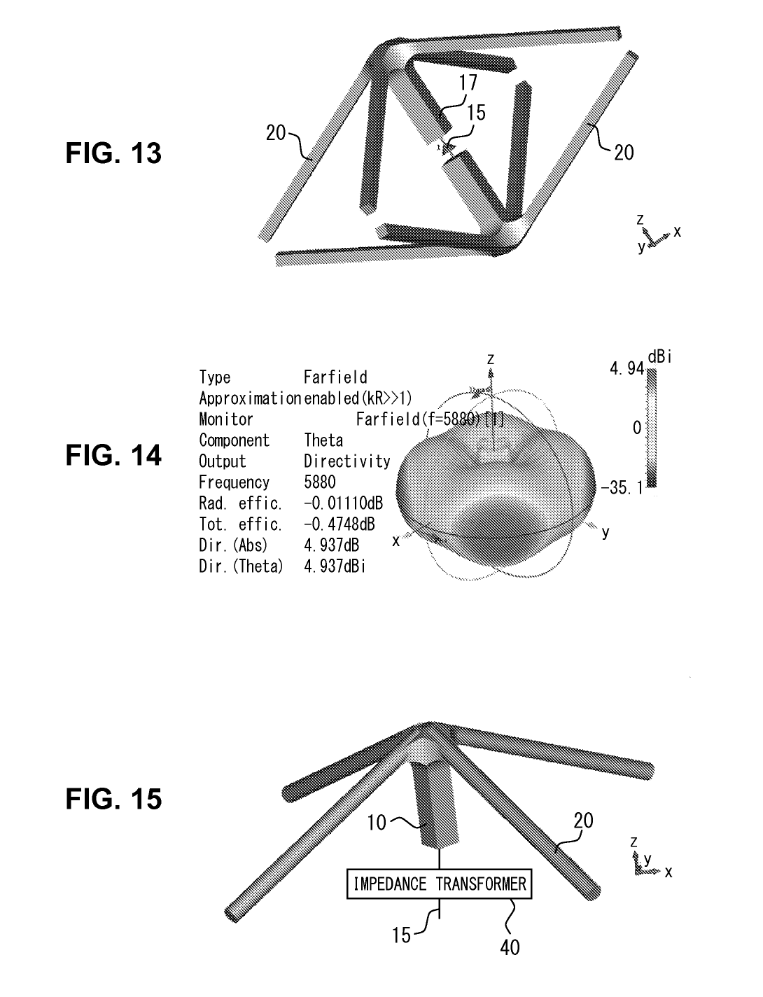

The line antenna element of the radiation antenna for wireless communication according to the first embodiment of the present invention is described above as a monopole antenna element. Now, a dipole antenna structure will be described below. FIG. 13 is a schematic perspective view of a radiation antenna for wireless communication according to the second embodiment of the present invention. In FIG. 13, the same reference numerals as those in FIG. 1 denote the same parts as those in FIG. 1. This embodiment differs from the first embodiment in that a line antenna element 17 of this embodiment is a dipole antenna element. Arm elements 20 are connected to tip portions of both of the far sides from a power feed section 15 of the line antenna element 17. Structurally, two monopole antenna elements like that of the first embodiment are arranged oppositely in this embodiment. With such a structure, the radiation antenna for wireless communications according to the second embodiment of the present invention provides effects and advantages similar to those of the first embodiment.

FIG. 14 is a view illustrating the results of a simulation of the directionality of the radiation antenna for wireless communication according to the second embodiment of the present invention as shown in FIG. 13. It will also be seen that regions of the highest gain are found in horizontal directions and in the directions where the arm elements are found and hence in the direction of the open ends of the arm elements. By comparing it with the radiation pattern obtained by using a monopole antenna element as shown in FIG. 3, it will be seen that same radiation patterns are formed symmetrically at the z-axis side and at the −z-axis side. The highest gain of the high gain regions is improved up to about 4.94 dBi. The antenna is designed so as to provide a high gain in all the four horizontal directions of the arm elements so that an antenna having directionality in a plurality of directions is realized.

While the four arm elements 20 are connected to the tip portion of each of the two far sides from the power feed section 15 of the line antenna element 17 in the illustrated example, the present invention is not limited thereto and a single arm element or a plurality of arm elements may be arranged at the tip portion of each of the two far sides as in the case of the first embodiment. As for the angle of the arm elements, it may be designed in various different ways to obtain a desired radiation pattern as in the case of the first embodiment.

Next, a radiation antenna for wireless communication according to the present invention that is designed to resonate at an even mode will be described below. The electrical length from the power feed section to an open end of the arm element through the line antenna element is designed so as to resonate at an odd mode of equal to or more than 3rd order mode in each of the above described examples. Now, an example where the electrical length is designed so as to make the antenna resonate at an even mode of equal to or more than 2nd order mode will be described below by referring to FIG. 15. FIG. 15 is a schematic perspective view of the radiation antenna for wireless communication according to the third embodiment of the present invention. In FIG. 15, the same reference numerals as those in FIG. 1 denote the same parts as those in FIG. 1.

When the electrical length from the power feed section 15 to an open end of the arm element 20 through the line antenna element 10 is designed so as to resonate at an even mode of equal to or more than 2nd order mode, it is equal to the wavelength of a target frequency. When the electrical length is designed to be equal to the wavelength, it is sufficient to make the line antenna element 10 equal to ¼ wavelength and the arm element 20 equal to ¾ wavelength. Note, however, that the ratio of the length of the line antenna element to that of the arm element is not limited to any particular number provided that the antenna is designed so as to resonate at an even mode of equal to or more than 2nd order mode.

In the case of an odd mode, the input impedance is high. Therefore, the radiation antenna for wireless communication according to the third embodiment of the present invention includes an impedance transformer 40 arranged at the power feed section 15 of the line antenna element 10 for impedance matching. Any of various types of impedance transformer 40 including the strip line type, the transformer type and the resistive type can be used for the purpose of the present invention. Desired characteristics can be obtained for a radiation antenna for wireless communication according to the present invention by using such an impedance transformer 40 for impedance matching.

Thus, a radiation antenna for wireless communication according to the present invention can be adapted to operate not only at an odd mode but also at an even mode.

A radiation antenna for wireless communication according to the present invention is not limited to the above illustrated embodiments, but various modifications may be made without departing from the scope of the present invention. The above-described results of simulations are only examples. An intended radiation pattern can be obtained by way of tuning etc. The expression of a “radiation antenna” is employed for an antenna for wireless communication according to the present invention in order to discriminate it from a so-called capacity antenna. However, it may be needless to say that a radiation antenna for wireless communication according to the present invention can be used not only for signal transmission but also for signal reception.

### EXPLANATION OF REFERENCE SYMBOLS

10: Line antenna element
15: Power feed section
17: Line antenna element
20: Arm element
30: Ground plane
40: Impedance transformer

What is claimed is:

1. A radiation antenna for wireless communication, comprising:
a line antenna element extending from a power feed section; and
at least an arm element connected to a tip portion of a far side of the power feed section of the line antenna element for enhancing gain and controlling directionality of the line antenna element,
an electrical length from the power feed section to an open end of the arm element through the line antenna element being designed to resonate at a higher order mode of a target frequency.

2. The radiation antenna for wireless communication according to claim 1, in which the electrical length from the power feed section to the open end of the arm element through the line antenna element is designed to resonate at an odd mode of equal to or more than 3rd order mode of a target frequency.

3. The radiation antenna for wireless communication according to claim 1, in which the electrical length from the power feed section to the open end of the arm element through the line antenna element is designed to resonate at an even mode of equal to or more than 2nd order mode of a target frequency,
and which further comprises an impedance transformer provided to the power feed section of the line antenna element.

4. The radiation antenna for wireless communication according to claim 1, in which the arm element is provided to tilt with respect to a longitudinal direction of the line antenna element.

5. The radiation antenna for wireless communication according to claim 1, in which the arm element is made by four arm elements.

6. The radiation antenna for wireless communication according to claim 5, in which the four arm elements are arranged every 90 degrees on a center of the tip portion of the line antenna element as viewed in a longitudinal direction of the line antenna element.

7. The radiation antenna for wireless communication according to claim 1, in which a shape of the arm element is any one of straight, helical, and meandrous.

8. The radiation antenna for wireless communication according to claim 1, in which the line antenna element comprises a dipole antenna element, and the arm element is connected to each of tip portions of both far sides of the power feed section of the dipole antenna element.
